(19) United States
(12) Patent Application Publication
(10) Pub. No.: US 2015/0128150 A1
(43) Pub. Date: May 7, 2015

(54) DATA PROCESSING METHOD AND INFORMATION PROCESSING APPARATUS

(71) Applicant: FUJITSU LIMITED, Kawasaki-shi (JP)

(72) Inventors: Haruyasu Ueda, Ichikawa (JP); YUICHI MATSUDA, Yokohama (JP)

(21) Appl. No.: 14/593,410

(22) Filed: Jan. 9, 2015

Related U.S. Application Data
(63) Continuation of application No. PCT/JP2012/069657, filed on Aug. 2, 2012.

(51) Int. Cl. G06F 9/50; G06F 9/48

(52) U.S. Cl. CPC G06F 9/5088; G06F 9/4881
USPC 718/105

(57) ABSTRACT

A system uses a plurality of nodes to perform a first process on an input data set and a second process on a result of the first process. In response to specification of an input data set including a first segment and a second segment on which the first process was previously performed, the system selects, from the plurality of nodes, a first node and a second node storing at least a part of the result of the first process previously performed on the second segment. The first node performs the first process on the first segment. The second node performs the second process on at least a part of the result of the first process on the first segment transferred from the first node, and at least the part of the result, which is stored in the second node, of the first process on the second segment.

### CROSS-REFERENCE TO RELATED APPLICATION

This application is a continuation application of International Application PCT/JP2012/069657 filed on Aug. 2, 2012 which designated the U.S., the entire contents of which are incorporated herein by reference.

### FIELD

The embodiments discussed herein relate to a data processing method and an information processing apparatus.

### BACKGROUND

Today, parallel data processing systems are being used, in which a plurality of nodes (e.g., a plurality of computers) connected to a network is operated in parallel to perform data processing. A parallel data processing system increases the speed of data processing by, for example, dividing a data set, allocating the resultant subsets to a plurality of nodes in a distributed manner, and independently performing data processing at each node. Parallel data processing systems are used for processing a large amount of data such as access log analysis of a server apparatus. A parallel data processing system may be implemented as a so-called cloud computing system. There are proposed frameworks such as MapReduce in order to assist creation of programs to be executed by a parallel data processing system.

Data processing defined by MapReduce includes two types of tasks: Map task and Reduce task. With MapReduce, an input data set is first divided into a plurality of subsets, and a Map task is activated for each subset of the input data. Since there is no dependence between Map tasks, it is possible to perform a plurality of Map tasks in parallel. Next, a set of intermediate data is divided into a plurality of subsets by sorting, according to a key, records included in the intermediate data set output from the plurality of Map tasks. On this occasion, a record in the intermediate data set may be transferred between a node which has performed a Map task and a node which will perform a Reduce task. A Reduce task is then activated for each subset of the intermediate data set. A Reduce task aggregates, for example, values of a plurality of records with the same key. Since there is no dependence between Reduce tasks, it is possible to perform a plurality of Reduce tasks in parallel.

There is proposed a distributed processing system which checks the connection relation between a plurality of slave nodes and a plurality of switches, groups the slave nodes based on the connection relation, and performs control so that a plurality of data blocks divided from a single data set is arranged in the same group. In addition, there is proposed a distributed processing system which checks the change of the amount of data before and after processing and increases the speed of data processing considering the traffic between nodes, by setting the degree of distribution high when the amount of data decreases, and setting the degree of distribution low when the amount of data increases.

Japanese Laid-Open Patent Publication No. 2010-244469

Japanese Laid-Open Patent Publication No. 2010-244470

Jeffrey Dean and Sanjay Ghemawat, “MapReduce: Simplified Data Processing on Large Clusters”, Proc. of the 6th Symposium on Operating Systems Design and Implementation, pp. 137-150, December 2004

As described above, there is conceivable an information processing system which uses a plurality of nodes to perform a first-stage process on an input data set and a second-stage process on the result of the first-stage process. Here, when the input data set to be processed this time includes a part common to a previously processed input data set, it is preferable that the result of the previous first-stage process corresponding to the common part is reusable. However, there is a problem that starting data processing without considering where the result of the first-stage process to be reused is stored may lead to increase in the number of data transfers to the node which performs the second-stage process, resulting in a large communication overhead.

### SUMMARY

According to an aspect, there is provided a data processing method performed by a system which uses a plurality of nodes to perform a first process on an input data set and a second process on a result of the first process. The method includes: selecting, by a processor, a first node and a second node from the plurality of nodes, in response to a specification of an input data set including a first segment and a second segment, the second segment being on which the first process was previously performed, the second node storing at least a part of a result of the first process previously performed on the second segment; instructing, by the processor, the first node to perform the first process on the first segment and to transfer at least a part of a result of the first process on the first segment to the second node; and instructing, by the processor, the second node to perform the second process on the at least part of the result of the first process on the first segment transferred from the first node, and the at least part of the result, which has been stored in the second node, of the first process previously performed on the second segment.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing system of a first embodiment;

FIG. 2 illustrates an information processing system of a second embodiment;

FIG. 3 is a block diagram illustrating exemplary hardware of a master node;

FIG. 4 illustrates a first exemplary flow of a MapReduce process;

FIG. 5 illustrates a second exemplary flow of the MapReduce process;

FIG. 6 is a block diagram illustrating an exemplary function of a master node;

FIG. 7 is a block diagram illustrating an exemplary function of a slave node;

FIG. 8 illustrates an exemplary job list;

FIG. 9 illustrates an exemplary task list;

FIG. 10 illustrates an exemplary Map management table and a Reduce management table;

FIG. 11 illustrates an exemplary Map task notification to be transmitted to a slave node;

FIG. 12 is a flowchart illustrating an exemplary procedure of master control;

FIG. 13 is a flowchart illustrating an exemplary procedure of Map information supplement;

FIG. 14 is a flowchart illustrating an exemplary procedure of Reduce information supplement;

FIG. 15 is a flowchart illustrating an exemplary procedure of a task completion process;

FIG. 16 is a flowchart illustrating an exemplary procedure of task allocation;

FIG. 17 is a flowchart illustrating an exemplary procedure of slave control;

FIG. 18 is a flowchart illustrating an exemplary procedure of intermediate data acquisition;

FIG. 19 is a flowchart illustrating an exemplary procedure of management table update; and

FIG. 20 illustrates an exemplary sequence of a MapReduce process.

### DESCRIPTION OF EMBODIMENTS

Several embodiments will be described below with reference to the accompanying drawings, wherein like reference numerals refer to like elements throughout.

### First Embodiment

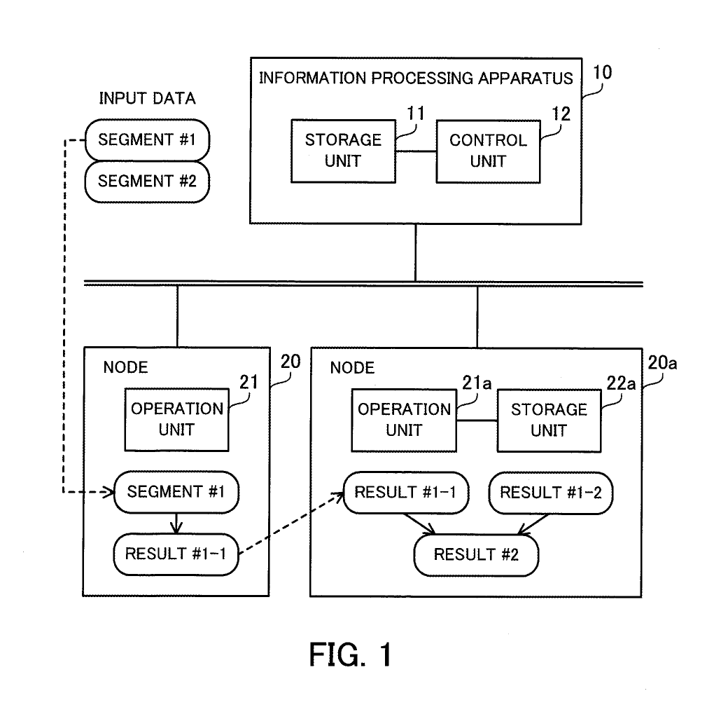

FIG. 1 illustrates an information processing system of a first embodiment. The information processing system of the first embodiment uses a plurality of nodes to perform a first process on an input data set, and performs a second process on the result of the first process. When using MapReduce, which is a framework of parallel data processing, processing of Map task is an example of the first process, and processing of Reduce task is an example of the second process. The information processing system includes an information processing apparatus 10 and a plurality of nodes including nodes 20 and 20a. The information processing apparatus 10 and the plurality of nodes are connected to a network such as a wired LAN (Local Area Network).

The information processing apparatus 10 is a management computer which allocates a first and a second process to a plurality of nodes. The information processing apparatus 10 may be referred to as a master node. The information processing apparatus 10 has a storage unit 11 and a control unit 12. The storage unit stores information indicating a correspondence relation between a segment included in a previously processed input data set and a node storing at least a part of the result of the previously performed first process. The control unit 12 determines a reusable result of the first process with reference to the information stored in the storage unit 11, in response to specification of an input data set, and selects a node which performs the first process and a node which performs the second process, from among the plurality of nodes.

Each of the plurality of nodes including the nodes 20 and 20a is a computer which performs at least one of the first and second processes, in response to an instruction from the information processing apparatus 10. Each node may be referred to as a slave node. The node 20 has an operation unit 21 and the node 20a has an operation unit 21a and a storage unit 22a. The operation units 21 and 21a perform the first or second process. For example, the operation unit 21 performs the first process, and the operation unit 21a obtains the result of the first process performed by the operation unit 21 and performs the second process. The storage unit 22a stores at least a part of the result of the previously performed first process. Also the node 20 may have a storage unit.

The storage unit 11, 22a may be a volatile memory such as a RAM (Random Access Memory), or may be a nonvolatile storage device such as an HDD (Hard Disk Drive) or a flash memory. The control unit 12 and the operation units 21 and 21a may be processors such as a CPU (Central Processing Unit) and a DSP (Digital Signal Processor), or may be other electronic circuits such as an ASIC (Application Specific Integrated Circuit) and an FPGA (Field Programmable Gate Array). A processor executes, for example, a program stored in the memory. A processor may include a dedicated electronic circuit for data processing, in addition to a calculator or a register which executes program instructions.

Now, let us consider a case where an input data set is specified, which may be divided into a plurality of segments including segments #1 and #2. The segment #2 is a subset of the input data on which the first process was previously performed. The segment #1 may be a subset of the input data on which the first process was not previously performed. In addition, it is assumed that at least a part of the result of the first process on the segment #2 (result #1-2) is stored in the storage unit 22a.

In the above case, the control unit 12 selects the node 20 (first node) from among the plurality of nodes. In addition, the control unit 12 searches for and selects the node 20a (second node) storing the result #1-2 from among the plurality of nodes, referring to the information stored in the storage unit 11. The control unit 12 instructs the selected node 20 to perform the first process on the segment #1, and instructs the selected node 20a to perform the second process. The first process on the segment #2 may be omitted by reusing the result #1-2.

Accordingly, the operation unit 21 performs the first process on the segment #1. At least a part of the result of the first process on the segment #1 (result #1-1) is transferred from the node 20 to the node 20a. The operation unit 21a merges the result #1-1 transferred from the node 20 and the result #1-2 stored in the storage unit 22a to perform the second process.

The result #1-2 stored in the storage unit 22a may be a set of records having a predetermined key, among the records included in the result of the first process on the segment #2. In addition, the result #1-1 transferred from the node 20 to the node 20a may be a set of records having a predetermined key, among the records included in the result of the second process on the segment #1. In the second process, for example, values of a plurality of records with the same key are aggregated to generate the result of the second process (result #2) with regard to the key. In addition, the node 20a may be a node which previously performed the second process on the result #1-2. The node 20a may store the result #1-1 received from the node 20 in the storage unit 22a.

According to the information processing system of the first embodiment, at least a part of the result of the first process previously performed on the segment #2 is reused so that the first process to be performed on the segment #2 may be omitted. Therefore, the amount of computing of data processing may be reduced. In addition, the second process is allocated to the node 20a storing at least a part of the result of the first process on the segment #2. Therefore, the number of transfers of the result of the first process for reuse may be reduced, which makes it possible to increase the efficiency of data processing, and to reduce the load of the network as well.

### Second Embodiment

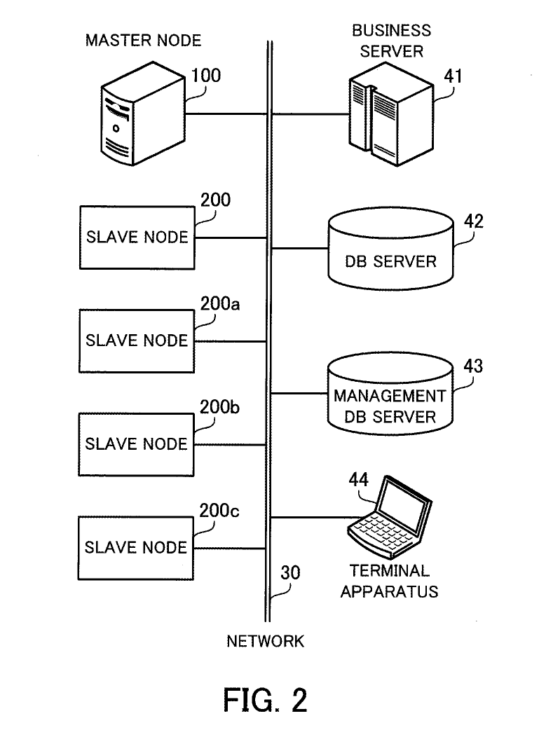

FIG. 2 illustrates an information processing system of a second embodiment. The information processing system of the second embodiment uses MapReduce to realize parallel data processing. Hadoop, for example, is such software that implements MapReduce. The information processing system includes a business server 41, a database (DB) server 42, a management DB server 43, a terminal apparatus 44, a master node 100, and slave nodes 200, 200a, 200b and 200c. Each of the aforementioned apparatuses is connected to a network 30.

The business server 41 is a server computer used for business such as electronic commerce. The business server 41 receives access from a user-operated client computer (not illustrated) via the network 30 or other networks, and performs predetermined information processing using application software. The business server 41 then generates log data indicating the execution status of the information processing, and stores the log data in the DB server 42.

The DB server 42 and the management DB server 43 are server computers which store data and perform search or update of data in response to access from other computers. Data stored in the DB server 42 (e.g., log data generated by the business server 41) may be used as input data to be analyzed by the slave nodes 200, 200a, 200b and 200c. The management DB server 43 stores management information for controlling data analysis to be performed by the slave nodes 200, 200a, 200b and 200c. The DB server 42 and the management DB server 43 may be integrated into a single DB server.

The terminal apparatus 44 is a client computer operated by a user (including the administrator of the information processing system). In response to a user operation, the terminal apparatus 44 transmits, to the master node 100, a command for starting analysis of the data stored in the DB server 42 or the slave nodes 200, 200a, 200b and 200c. The command specifies a file including data to be analyzed and a file of a program defining the processing procedure. The program file is preliminarily uploaded from the terminal apparatus 44 to the master node 100, for example.

The master node 100 is a server computer which controls the slave nodes 200, 200a, 200b and 200c to realize parallel data processing. Upon receiving the command from the terminal apparatus 44, the master node 100 divides the input data set into a plurality of segments, and defines a plurality of Map tasks which process the segments of the input data to generate an intermediate data set. In addition, the master node 100 defines one or more Reduce tasks which aggregate the intermediate data sets. The master node 100 then allocates the Map tasks and the Reduce tasks to the slave nodes 200, 200a, 200b and 200c in a distributed manner. The program file specified in the command is placed at the slave nodes 200, 200a, 200b and 200c by the master node 100, for example.

The slave nodes 200, 200a, 200b and 200c are server computers which perform at least one of the Map task and the Reduce task in response to the instruction from the master node 100. One of the slave nodes may perform both the Map task and the Reduce task. The plurality of Map tasks is independent of each other and therefore may be performed in parallel, and the plurality of Reduce tasks is independent of each other and therefore may be performed in parallel. There may be a case where intermediate data sets are transferred from a node which performs a Map task to a node which performs a Reduce task.

The master node 100 is an example of the information processing apparatus 10 described in the first embodiment. In addition, each of the slave nodes 200, 200a, 200b and 200c is an example of the node 20 or the node 20a described in the first embodiment.

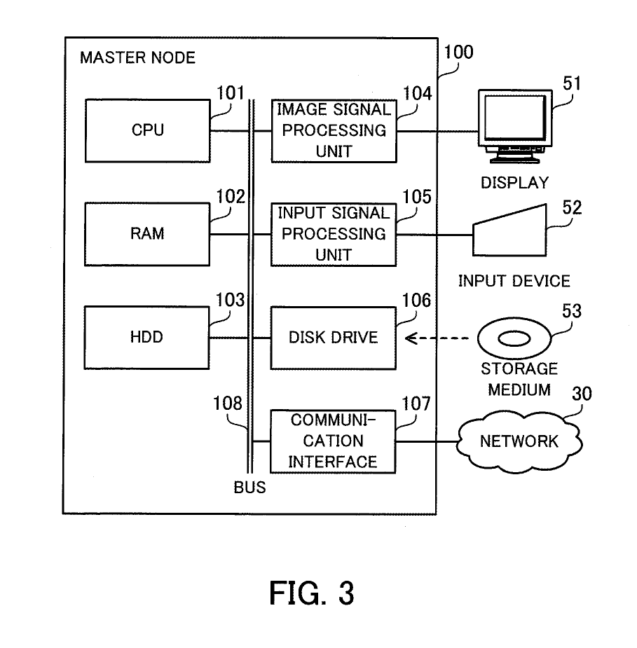

FIG. 3 is a block diagram illustrating exemplary hardware of a master node. The master node 100 has a CPU 101, a RAM 102, an HDD 103, an image signal processing unit 104, an input signal processing unit 105, a disk drive 106, and a communication interface 107. Each of the aforementioned units is connected to a bus 108 included in the master node 100.

The CPU 101 is a processor including a calculator which executes a program instruction. The CPU 101 loads, to the RAM 102, at least a part of a program or data stored in the HDD 103 and executes the program. The CPU 101 may include a plurality of processor cores, the master node 100 may include a plurality of processors and may perform the processes described below in parallel, using a plurality of processors or a processor cores.

The RAM 102 is a volatile memory temporarily storing a program executed by the CPU 101 or data used for calculation. The master node 100 may include a different type of memory other than a RAM, or may include a plurality of volatile memories.

The HDD 103 is a nonvolatile storage device storing programs and data for software such as the OS (Operating System), firmware or application software. The master node 100 may include a different type of storage device such as a flash memory or an SSD (Solid State Drive), or may include a plurality of nonvolatile storage devices.

The image signal processing unit 104 outputs an image to a display 51 connected to the master node 100, in response to an instruction from the CPU 101. A CRT (Cathode Ray Tube) display or a liquid crystal display may be used as the display 51.

The input signal processing unit 105 obtains an input signal from an input device 52 connected to the master node 100, and notifies the CPU 101 of the input signal. A pointing device such as a mouse or a touch panel, a keyboard or the like may be used as the input device 52.

The disk drive 106 is a drive device which reads programs or data stored in a storage medium 53. A magnetic disk such as an FD (Flexible Disk) or an HDD, an optical disk such as a CD (Compact Disc) or a DVD (Digital Versatile Disc), or Magneto-Optical disk (MO), for example, may be used as the storage medium 53. In response to an instruction from the CPU 101, the disk drive 106 stores programs or data which has been read from the storage medium 53 in the RAM 102 or the HDD 103.

The communication interface 107 is an interface which communicates with other computers (e.g., the terminal apparatus 44, or the slave nodes 200, 200a, 200b and 200c) via the network 30. The communication interface 107 may be a wired interface for connecting to a wired network, or may be a wireless interface for connecting to a wireless network.

The master node 100, however, need not have a disk drive 106 and, when being accessed mainly from other computers, need not include the image signal processing unit 104 and the input signal processing unit 105. The business server 41, the DB server 42, the management DB server 43, the terminal apparatus 44, and the slave nodes 200, 200a, 200b and 200c may also be realized, using similar hardware to the master node 100. The CPU 101 is an example of the control unit 12 described in the first embodiment, and the RAM 102 or the HDD 103 is an example of the storage unit 11 described in the first embodiment.

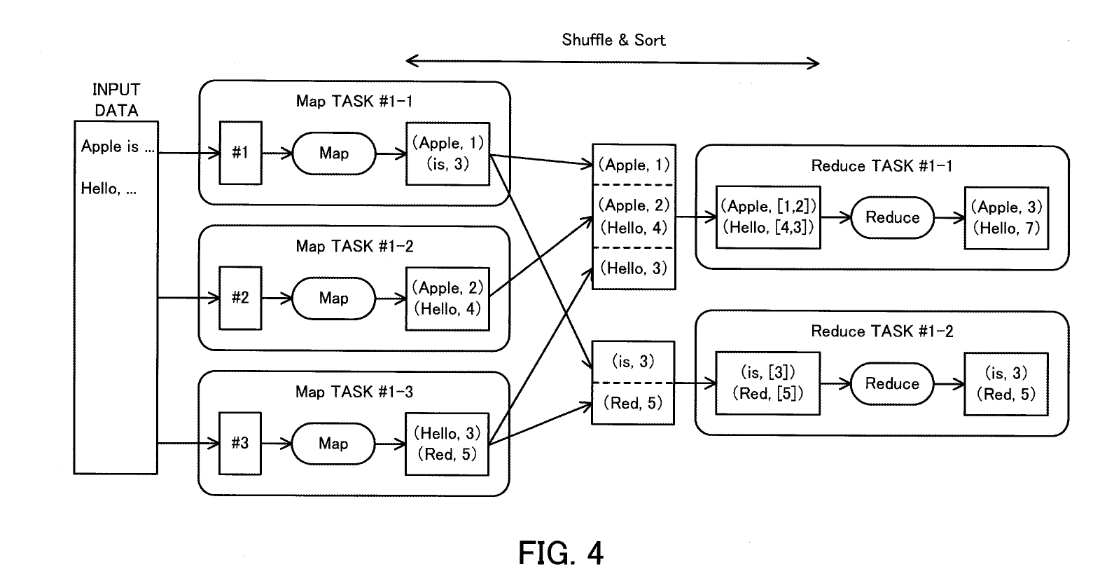

FIG. 4 illustrates a first exemplary flow of a MapReduce process. The data processing procedure defined in MapReduce includes dividing of the input data set, a Map phase, Shuffle & Sort of intermediate data sets, and a Reduce phase.

In the input data set dividing, an input data set is divided into a plurality of segments. In the example of FIG. 4, a character string as the input data set is divided into segments #1 to #3.

In the Map phase, a Map task is activated for each segment of input data. In the example of FIG. 4, a Map task #1-1 which processes a segment #1, a Map task #1-2 which processes a segment #2, and a Map task #1-3 which processes a segment #3 are activated. The plurality of Map tasks is performed independently of each other. The procedure of Map process performed by a Map task may be defined by a user using a program. In the example of FIG. 4, the Map process counts the number of times each word appears in a character string. Each Map task generates an intermediate data set including one or more records as a result of the Map process. A record of an intermediate data set is represented in a key-value format with a key and a value being paired. In the example of FIG. 4, each record includes a key representing a word and a value representing the number of times the word appears. There may be a one-to-one correspondence between a segment of input data and an intermediate data set.

With Shuffle & Sort, records included in the intermediate data set generated by a plurality of Map tasks are sorted and merged, according to a key. In other words, a Reduce task which handles a record is determined from the key of the record, and records with the same key are collected and merged. As a method of determining the Reduce task from the key, there is conceivable a method of allocating a number to each Reduce task as a hash value and calculating the hash value of the key for determination. However, a user may define a function to determine the Reduce task from the key. In the example of FIG. 4, records with the keys “Apple” and “Hello” are collected in one location, and records with the keys “is” and “Red” are collected in another location. By merging of records, values of records with the same key are grouped in a list form.

In the Reduce phase, a Reduce task is activated for each segment (a set of records handled by the same Reduce task) of the intermediate data set generated through Shuffle & Sort. In the example of FIG. 4, a Reduce task #1-1 which processes the records with the keys “Apple” and “Hello” and a Reduce task #1-2 which processes the records with the keys “is” and “Red” are activated. The plurality of Reduce tasks is performed independently of each other. The procedure of a Reduce process performed by a Reduce task may be defined by a user using a program. In the example of FIG. 4, the numbers of appearance times of the words enumerated in a list form are summed, as the Reduce process. Each Reduce task generates output data including records in the key-value format, as the result of the Reduce process.

Map tasks and Reduce tasks may be allocated to the slave nodes 200, 200a, 200b and 200c in a distributed manner. For example, the Map task #1-2 is allocated to the slave node 200, and the Reduce task #1-1 is allocated to the slave node 200a. In this case, records with the keys “Apple” and “Hello”, among the records included in the intermediate data set generated by the Map task #1-2, will be transferred from the slave node 200 to the slave node 200a

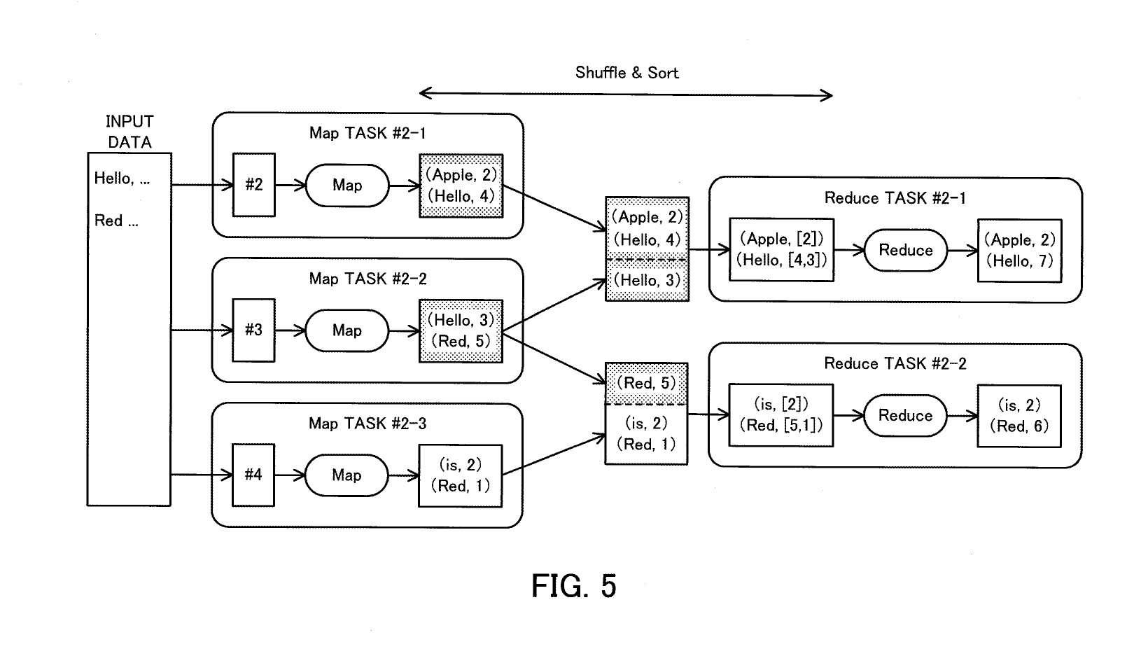

FIG. 5 illustrates a second exemplary flow of a MapReduce process. Here, let us consider a case where the MapReduce process illustrated in FIG. 5 is performed after the MapReduce process illustrated in FIG. 4. In the example of FIG. 5, an input data set is divided into segments #2 to #4. The segments #2 and #3 are identical to those illustrated in FIG. 4. In other words, a part of the input data set processed in FIG. 5 overlaps with the input data set processed in FIG. 4.

In the Map phase, a Map task #2-1 which processes the segment #2, a Map task #2-2 which processes the segment #3, and a Map task #2-3 which processes the segment #4 are activated. In the Reduce phase, a Reduce task #2-1 which processes the records with the keys “Apple” and “Hello” and a Reduce task #2-2 which processes the records with the keys “is” and “Red” are activated, similarly to the case of FIG. 4.

Here, the input data set of FIG. 5 is different from that of FIG. 4 in that the segment #4 is included but the segment #1 is not included in the input data set of FIG. 5. Accordingly, the result of the Reduce task #2-indicating the number of appearance times of “Apple” and “Hello” is different from the result of the Reduce task #1-1 illustrated in FIG. 4. In addition, the result of the Reduce task #2-2 indicating the number of appearance times of “is” and “Red” is different from the result of the Reduce task #1-2 illustrated in FIG. 4.

On the other hand, there is a one-to-one correspondence between the segment of input data and the intermediate data set resulted from the Map task. Accordingly, the result of the Map task #2-1 which processes the segment #2 is the same as the result of the Map task #1-2 illustrated in FIG. 4. In addition, the result of the Map task #2-2 which processes the segment #3 is the same as the result of the Map task #1-3 illustrated in FIG. 4. In other words, the intermediate data sets corresponding to the segments #2 and #3 are reusable. Here, the number of transfers of intermediate data sets between nodes may be reduced when reusing the intermediate data sets by storing the intermediate data sets collected from the Map tasks #1-2 and #1-3 in the node which has performed the Reduce task #1-1 and causing the node to perform the Reduce task #2-1. Similarly, the number of transfers of intermediate data sets between nodes may be reduced when reusing the intermediate data sets by storing the intermediate data sets collected from the Map task #1-3 in the node which has performed the Reduce task #1-2 and causing the node to perform the Reduce task #2-2. The master node 100 then makes the intermediate data sets reusable and allocates the Reduce tasks to the slave nodes 200, 200a, 200b and 200c so as to reduce the number of transfers of intermediate data sets.

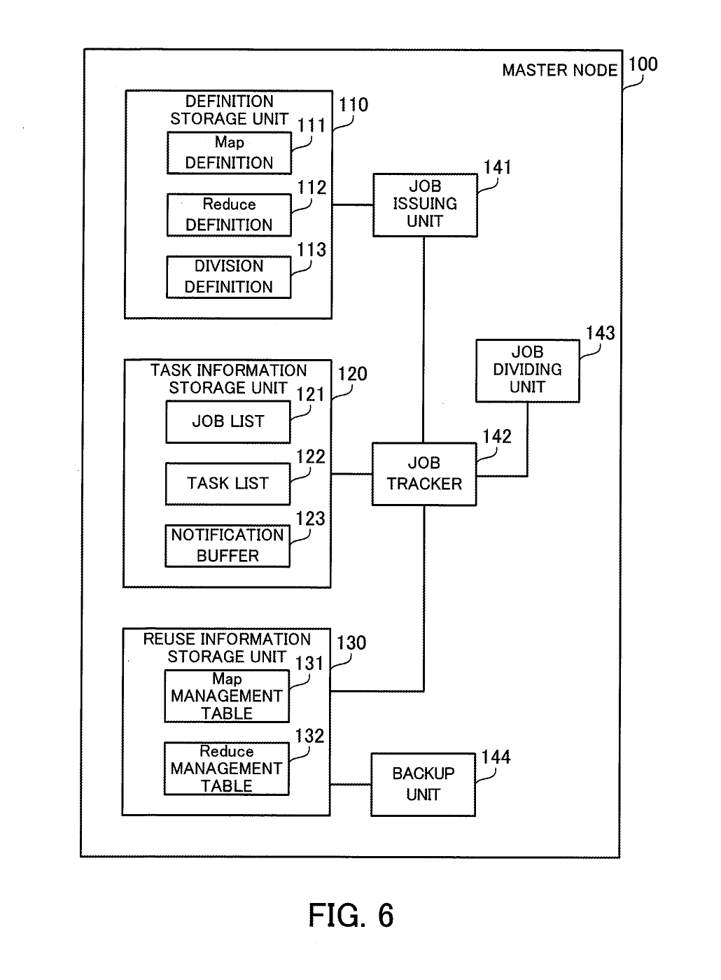

FIG. 6 is a block diagram illustrating an exemplary function of a master node. The master node 100 has a definition storage unit 110, a task information storage unit 120, a reuse information storage unit 130, a job issuing unit 141, a job tracker 142, a job dividing unit 143, and a backup unit 144. The definition storage unit 110, the task information storage unit 120, and the reuse information storage unit 130 are implemented as storage areas secured in the RAM 102 or the HDD 103, for example. The job issuing unit 141, the job tracker 142, the job dividing unit 143, and the backup unit 144 are implemented as program modules to be executed by the CPU 101, for example.

The definition storage unit 110 stores a Map definition 111, a Reduce definition 112, and a Division definition 113. The Map definition 111 defines the Map process. The Reduce definition 112 defines the Reduce process. The Division definition 113 defines the dividing method of the input data set. The Map definition 111, the Reduce definition 112 and the Division definition 113 are program modules (classes of an object-oriented program), for example.

The task information storage unit 120 stores a job list 121, a task list 122, and a notification buffer 123. The job list 121 is information indicating a list of jobs indicating a group of MapReduce processes. The task list 122 is information indicating a list of Map tasks and Reduce tasks defined for each job. The notification buffer 123 is a storage area for temporarily storing a notification (message) to be transmitted from the master node 100 to the slave nodes 200, 200a, 200b and 200c. When a notification is received from any of the slave nodes as a heartbeat, a notification stored in the notification buffer 123 and addressed to the slave node is transmitted to the slave node as a response.

The reuse information storage unit 130 stores a Map management table 131 and a Reduce management table 132. The Map management table 131 stores information indicating the node which previously performed a Map task and the intermediate data set stored in the node. The Reduce management table 132 stores information indicating the node which previously performed a Reduce task and the intermediate data set stored in the node. The intermediate data set previously generated is reused, based on the Map management table 131 and the Reduce management table 132.

Upon receiving a command from the terminal apparatus 44, the job issuing unit 141 requests the job tracker 142 to specify the Map definition 111, the Reduce definition 112, the Division definition 113 and an input data set which are used in MapReduce, and register a new job. In addition, when completion of the job is reported from the job tracker 142, the job issuing unit 141 transmits a message indicating job completion to the terminal apparatus 44.

The job tracker 142 manages the jobs and tasks (including Map tasks and Reduce tasks). When registration of a new job is requested from the job issuing unit 141, the job tracker 142 divides the input data set into a plurality of segments by invoking the job dividing unit 143. The job tracker 142 then defines and registers in the task list 122 a Map task and a Reduce task for implementing the job, and updates the job list 121 as well. On this occasion, the job tracker 142 determines whether any Map task may be omitted by reusing the intermediate data set, referring to the Map management table 131.

Upon defining a Map task and a Reduce task, the job tracker 142 allocates each task (except omitted Map tasks, if any) to one of the slave nodes, according to the availability of resources of the slave nodes 200, 200a, 200b and 200c. On this occasion, the job tracker 142 allocates each Reduce task preferentially to the slave node storing the intermediate data set for Reduce which is reusable by the Reduce task, according to the Reduce management table 132. Upon completion of the Map task and the Reduce task, the job tracker 142 registers information relating to the intermediate data set in the Map management table 131 and the Reduce management table 132.

When the job tracker 142 has generated a notification to be transmitted to the slave nodes 200, 200a, 200b and 200c, the job tracker 142 stores the notification in the notification buffer 123. Upon receiving a heartbeat from any of the slave nodes, the job tracker 142 transmits, as a response to the heartbeat, a notification stored in the notification buffer 123 and addressed to the slave node. In addition, when the job tracker 142 has allocated a Map task to any of the slave nodes, the job tracker 142 may provide the slave node with the Map definition 111. In addition, when the job tracker 142 has allocated a Reduce task to any of the slave nodes, the job tracker 142 may provide the slave node with the Reduce definition 112.

When invoked from the job tracker 142, the job dividing unit 143 divides the input data set into a plurality of segments, according to the dividing method defined in the Division definition 113. When the input data set includes a part on which a Map process was previously performed, it is preferred to divide the input data set so that the part on which a Map process was previously performed and the other parts belong to different segments. The input data set to be specified may be stored in the DB server 42, or may be stored in the slave nodes 200, 200a, 200b and 200c.

The backup unit 144 backs up the Map management table 131 and the Reduce management table 132 to the management DB server 43 via the network 30. Backup by the backup unit 144 may be regularly performed, or may be performed when the Map management table 131 and the Reduce management table 132 are updated.

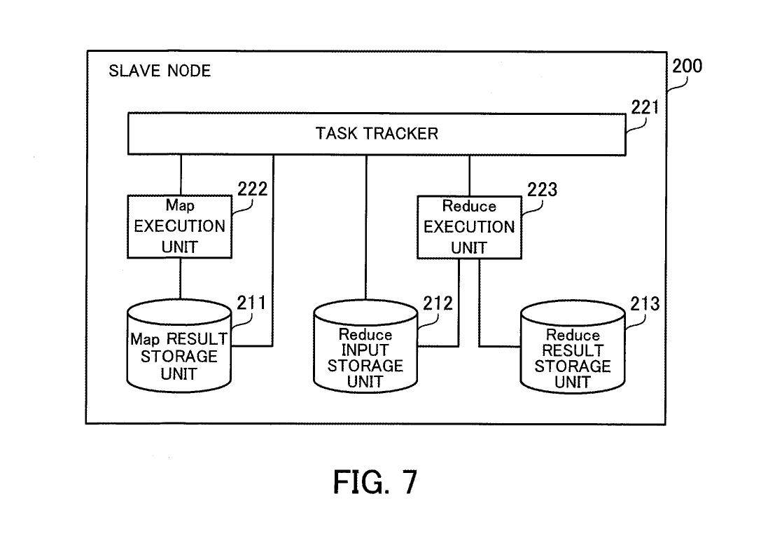

FIG. 7 is a block diagram illustrating an exemplary function of a slave node. The slave node 200 has a Map result storage unit 211, a Reduce input storage unit 212, a Reduce result storage unit 213, a task tracker 221, a Map execution unit 222, and a Reduce execution unit 223. The Map result storage unit 211, the Reduce input storage unit 212, and the Reduce result storage unit 213 are implemented as storage areas secured in the RAM or the HDD, for example. The task tracker 221, the Map execution unit 222, and the Reduce execution unit 223 are implemented as program modules to be executed by CPU, for example. The slave nodes 200a, 200b and 200c also have a similar function to the slave node 200.

The Map result storage unit 211 stores the intermediate data set representing the result of the Map task performed by the slave node 200. The Map result storage unit 211 manages the results of a plurality of Map tasks in respective directories. The path name of a directory is defined such as “/job_ID/task_ID_of_Map_task/out”, for example.

When the slave node 200 performs a Reduce task, the Reduce input storage unit 212 stores intermediate data sets collected from the nodes which have performed Map tasks. The Reduce input storage unit 212 manages intermediate data sets relating to a plurality of Reduce tasks in respective directories. The path name of a directory is defined such as “/job_ID/task_ID_of_Reduce_task/in”, for example.

The Reduce result storage unit 213 stores an output data set representing the result of a Reduce task performed by the slave node 200. The output data set stored in the Reduce result storage unit 213 may be used as an input data set for a job to be subsequently performed.

The task tracker 221 manages the tasks (including Map tasks and Reduce tasks) allocated to the slave node 200. The slave node 200 has set therein an upper limit of the number of Map tasks and an upper limit of the number of Reduce tasks which may be performed in parallel. When the number of Map tasks or Reduce tasks being performed has not reached the upper limit, the task tracker 221 transmits a task request notification to the master node 100. The task tracker 221 invokes the Map execution unit 222 when a Map task is allocated from the master node 100 in response to the task request notification, or invokes the Reduce execution unit 223 when a Reduce task is allocated in response to the task request notification. Upon completion of any of the tasks, the task tracker 221 transmits a task completion notification to the slave node 200.

In addition, when there is a transfer request from another slave node performing the Reduce task after completion of the Map task, the task tracker 221 transmits at least a part of the intermediate data set stored in the Map result storage unit 211. In addition, when a Reduce task is allocated to the slave node 200, the task tracker 221 makes a transfer request to another slave node which has performed the Map task, and stores the received intermediate data set in the Reduce input storage unit 212. The task tracker 221 merges the collected intermediate data sets.

When invoked from the task tracker 221, the Map execution unit 222 performs the Map process defined in the Map definition 111. The Map execution unit 222 stores the intermediate data set generated by the Map task in the Map result storage unit 211. On this occasion, the Map execution unit 222 sorts a plurality of records in the key-value format, based on a key, and creates a file for each set of records allocated to the same Reduce task. One or more files, numbered according to the transfer-destination Reduce task, are supposed to be stored in a directory identified by the job ID and the task ID of the Map task.

When invoked from the task tracker 221, the Reduce execution unit 223 performs a Reduce process defined in the Reduce definition 112. The Reduce execution unit 223 stores the output data set generated by the Reduce task in the Reduce result storage unit 213. The Reduce input storage unit 212 has one or more files with the task ID of the transfer-source Map task stored in the directory identified by the job ID and the task ID of the Reduce task. Records in the key-value format included in the files are sorted and merged, based on the key.

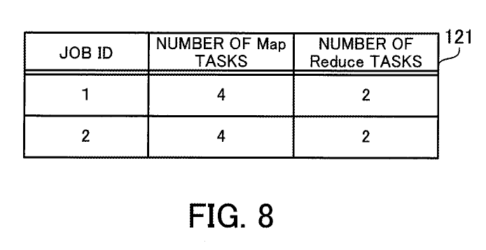

FIG. 8 illustrates an exemplary job list. The job list 121 includes columns for job ID, number of Map tasks, and number of Reduce tasks. The column for job-ID has registered therein an identification number provided by the job tracker 142 to each job. The column for number of Map tasks has registered therein the number of Map tasks defined by the job tracker 142 with regard to the job indicated by the job ID. The column for number of Reduce tasks has registered therein the number of Reduce tasks defined by the job tracker 142 with regard to the job indicated by the job ID.

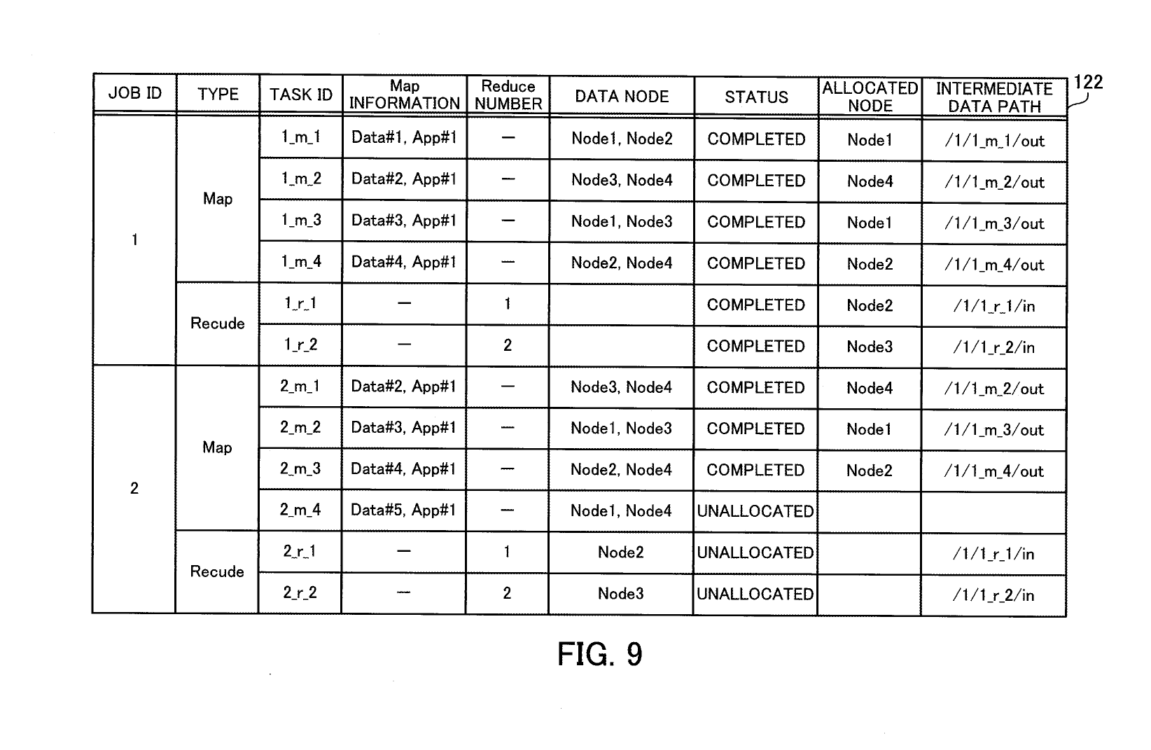

FIG. 9 illustrates an exemplary task list. The task list 122 is successively updated by the job tracker 142 according to the progress of the Map task or the Reduce task. The task list 122 includes columns for job ID, type, task ID, Map information, Reduce number, data node, status, allocated node, and intermediate data path.

The column for job-ID has registered therein an identification number of a job, similarly to the job list 121. The column for type has registered therein “Map” or “Reduce” as the type of a task. The column for task ID has registered therein an identifier provided to each task by the job tracker 142. The task ID includes, for example, a symbol (m or r) indicating the job ID and the type of the task, and a number indicating the Map task or the Reduce task in a job.

The column for Map information has registered therein identification information of a segment of input data and identification information of the Map definition 111. The identification information of a segment includes, for example, a file name, an address indicating the top position of the segment in the file, and a segment size. The identification information of the Map definition 111 includes, for example, a name of a class as a program module. The column for Reduce number has registered therein a number uniquely assigned to each Reduce task in a job. The Reduce number may be a hash value calculated when a hash function is applied to a key of a record in an intermediate data set.

The column for data node has registered therein, for a Map task, an identifier of the slave node or the DB server 42 storing the input data set for use in the Map process. In addition, the column for data node has registered therein, for a Reduce task, an identifier of the slave node storing the intermediate data set representing the Reduce input (intermediate data sets collected by one or more Map tasks). When not reusing the intermediate data set representing the Reduce input, the column for data node is left blank. There may also be a case in which a plurality of slave nodes storing input data sets or intermediate data sets exists. In FIG. 9, Node 1 indicates the slave node 200, Node 2 indicates the slave node 200a, Node 3 indicates the slave node 200b, and Node 4 indicates the slave node 200c.

The column for status has registered therein one of “unallocated”, “running”, and “completed” as the status of a task. “Unallocated” is a status indicating that no slave node has been determined to perform a task. “Running” is a status indicating that, after a task is allocated to one of the slave nodes, the task has not been completed in the slave node. “Completed” is a status indicating that a task has been normally completed. The column for allocated node has registered therein an identifier of a slave node to which a task has been allocated. The column for allocated node is left blank for an unallocated task.

The column for intermediate data path has registered therein, for a Map task, the path of the directory storing the intermediate data set representing the Map result in the slave node having performed the Map task. The column for intermediate data path is left blank for an unallocated or running Map task. In addition, the column for intermediate data path has registered therein, for a Reduce task, the path of the directory storing the intermediate data set representing the Reduce input. When reusing the intermediate data set representing the Reduce input, the path for the slave node indicated by the column for data node is registered. When not reusing the intermediate data set representing the Reduce input, the path for the slave node indicated by the column for allocated node is registered. The column for intermediate data path is left blank when not reusing the intermediate data set representing the Reduce input, and for an unallocated or running Reduce task as well.

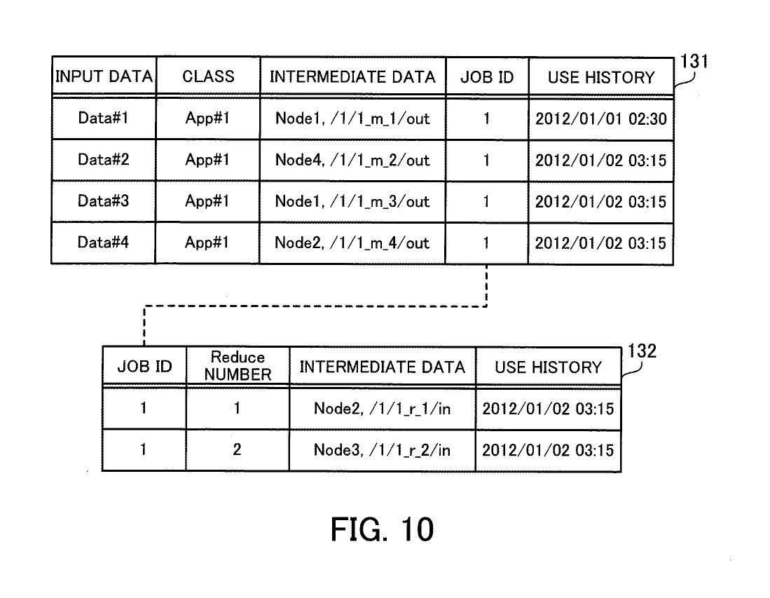

FIG. 10 illustrates an exemplary Map management table and an exemplary Reduce management table. The Map management table 131 and the Reduce management table 132 are managed by the job tracker 142, and backed up by the management DB server 43.

The Map management table 131 includes columns for input data set, class, intermediate data set, job ID, and use history. The column for input data set has registered therein identification information of a segment of input data, similarly to the Map information of the task list 122. The column for class has registered therein identification information of the Map definition 111, similarly to the Map information of the task list 122. The column for intermediate data set has registered therein an identifier of a slave node storing an intermediate data set representing the Map result and a path of a directory thereof. The column for job ID has registered therein an identification number of a job to which a Map task belongs. The column for use history has registered therein information indicating the reuse status of the intermediate data set representing the Map result. The use history includes, for example, a date and time when an intermediate data set was finally referred to.

The Reduce management table 132 includes columns for job ID, Reduce number, intermediate data set, and use history. The column for job ID has registered therein an identification number of a job to which a Reduce task belongs. It turns out that a record of the Map management table 131 and a record of the Reduce management table 132 are associated with each other via the job ID. The column for Reduce number has registered therein a number uniquely assigned to each Reduce task in a job. The column for intermediate data set has registered therein an identifier of a slave node storing an intermediate data set representing the Reduce input and a path of a directory thereof. The column for use history has registered therein information indicating the reuse status of the intermediate data set representing the Reduce input.

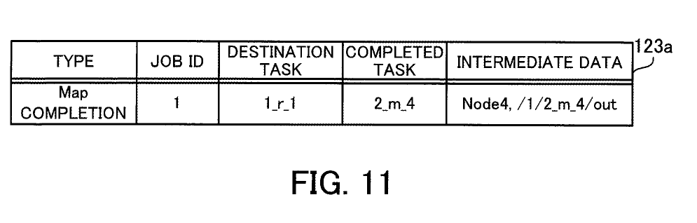

FIG. 11 illustrates an exemplary Map task notification to be transmitted to a slave node. A Map task notification 123a is generated by the job tracker 142 and stored in the notification buffer 123, when any of the Map tasks is completed. The Map task notification 123a stored in the notification buffer 123 is transmitted to a slave node having allocated thereto a Reduce task belonging to the same job as the completed Map task. The Map task notification 123a includes columns for type, job ID, destination task, completed task, and intermediate data set.

The column for type has registered therein a message type of the Map task notification 123a, i.e., information indicating that the Map task notification 123a is a message for reporting Map completion from the master node 100 to one of the slave nodes. The column for job ID has registered therein an identification number of a job to which a completed Map task belongs. The column for destination task has registered therein an identifier of a Reduce task to which the Map task notification 123a is addressed. The column for completed task has registered therein an identifier of a completed Map task. The column for intermediate data set has registered therein an identifier of a slave node which has performed a Map task, and a path of a directory storing in the slave node an intermediate data set representing the Map result.

Next, processes to be performed by the master node 100 and the slave node 200 will be described. The process performed by the slave nodes 200a, 200b and 200c is similar to that of the slave node 200.

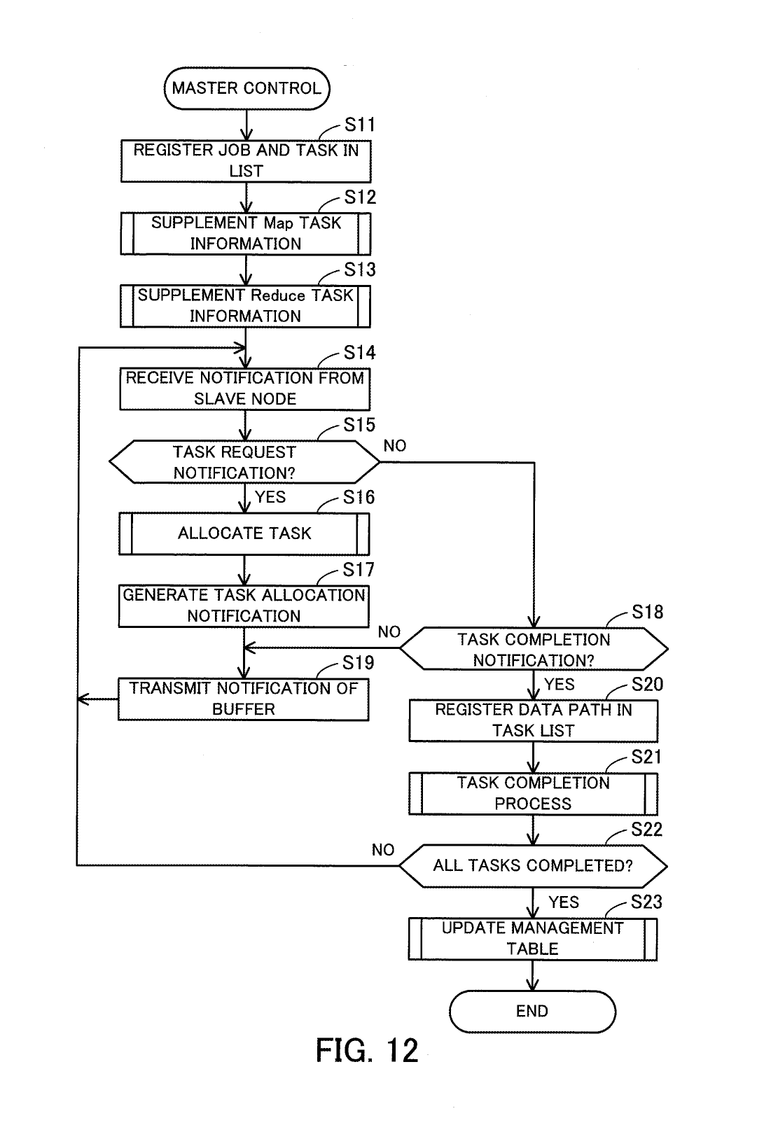

FIG. 12 is a flowchart illustrating an exemplary procedure of master control.

(Step S11) The job dividing unit 143 divides the input data set into a plurality of segments in response to a request from the job issuing unit 141. The job tracker 142 defines a Map task and a Reduce task of a new job, according to the result of dividing the input data set. The job tracker 142 then registers the job in the job list 121, and registers the Map task and the Reduce task in the task list 122.

(Step S12) Referring to the Map management table 131 stored in the reuse information storage unit 130, the job tracker 142 supplements the information of the Map task added to the task list 122 in step S11. Details of the Map information supplement will be described below.

(Step S13) Referring to the Reduce management table 132 stored in the reuse information storage unit 130, the job tracker 142 supplements the information of the Reduce task added to the task list 122 in step S11. Details of the Reduce information supplement will be described below.

(Step S14) The job tracker 142 receives a notification as a heartbeat from one of the slave nodes (e.g., the slave node 200). Types of receivable notification include: a task request notification indicating a request to allocate a task, a task completion notification indicating that a task has completed, and a checking notification for checking the presence or absence of a notification addressed to the slave node.

(Step S15) The job tracker 142 determines whether or not the notification received at step S14 is a task request notification. The process flow proceeds to step S16 when the received notification is a task request notification, and the process flow proceeds to step S18 when it is not a task request notification.

(Step S16) The job tracker 142 allocates one or more unallocated tasks to the slave node which has transmitted the task request notification. Details of the task allocation will be described below.

(Step S17) The job tracker 142 generates, and stores in the notification buffer 123, a task allocation notification for the slave node which has transmitted the task request notification. The task allocation notification includes a record of the task list 122 relating to the task allocated at step S16 and a record of the job list 121 relating to the job to which the task belongs.

(Step S18) The job tracker 142 determines whether or not the notification received at step S14 is a task completion notification. The process flow proceeds to step S20 when the received notification is a task completion notification, and proceeds to step S19 when it is not a task completion notification.

(Step S19) The job tracker 142 reads, from the notification buffer 123, a notification supposed to be transmitted to the slave node which has transmitted the notification received at step S14. The job tracker 142 transmits the notification read from the notification buffer 123 as a response to the notification received at step S14. The process flow then proceeds to step S14.

(Step S20) The job tracker 142 extracts, from the task completion notification, information indicating the path of the directory storing the intermediate data set, and registers the information in the task list 122.

(Step S21) The job tracker 142 performs a predetermined task completion process on the task whose completion has been reported by the task completion notification. Details of the task completion process will be described below.

(Step S22) Referring to the task list 122, the job tracker 142 determines, for the job to which the task belongs whose completion has been reported in the task completion notification, whether or not all the tasks have been completed. The process flow proceeds to step S23 when all the tasks have been completed, and proceeds to step S14 when there exists one or more uncompleted tasks.

(Step S23) The job tracker 142 updates the Map management table 131 and the Reduce management table 132. Details of management table update will be described below.

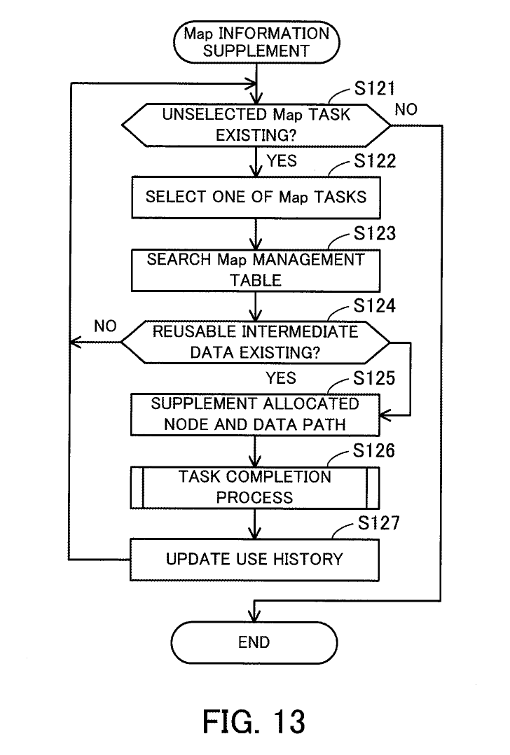

FIG. 13 is a flowchart illustrating an exemplary procedure of Map information supplement. The procedure illustrated in the flowchart of FIG. 13 is performed at step S12 described above.

(Step S121) The job tracker 142 determines whether or not there exists an unselected Map task in the Map task defined at step S11 described above. The process flow proceeds to step S122 when there exists an unselected Map task, and the process is terminated when all the Map tasks have been selected.

(Step S122) The job tracker 142 selects one of the Map tasks defined at step S11 described above.

(Step S123) The job tracker 142 searches the Map management table 131 for a record having an input data set and a class to be used in the Map process which are common to those in the Map task selected at step S122. The input data set and the class relating to the selected Map task are described in the column for Map information of the task list 122.

(Step S124) The job tracker 142 determines whether or not a corresponding record has been searched at step S123, in other words, whether or not there exists a reusable Map result for the Map task selected at step S122. The process flow proceeds to step S125 when there is a reusable Map result, and proceeds to step S121 when there is none.

(Step S125) The job tracker 142 supplements the information of the columns for allocated node and intermediate data path included in the task list 122. The allocated nodes and intermediate data paths are described in the column for intermediate data set of the Map management table 131.

(Step S126) The job tracker 142 performs a task completion process described below, and treats the Map task selected at step S122 as the already-completed task. Using the previously generated intermediate data set eliminates the necessity of performing the Map task concerned.

(Step S127) The job tracker 142 updates the use history of the record searched from the Map management table 131 at step S123. For example, the job tracker 142 rewrites the use history to the current date and time. The process flow then proceeds to step S121.

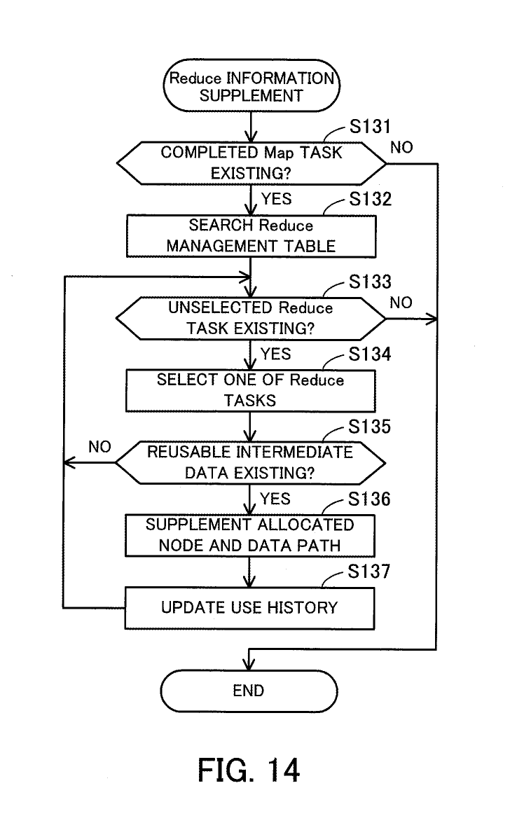

FIG. 14 is a flowchart illustrating an exemplary procedure of Reduce information supplement. The procedure illustrated in the flowchart of FIG. 14 is performed at step S13 described above.

(Step S131) The job tracker 142 determines whether or not there exist one or more Map tasks determined at step S12 to have been completed. The process flow proceeds to step S132 when there exists a Map task determined to have been completed, otherwise the process is terminated.

(Step S132) The job tracker 142 checks the job ID included in the record searched from the Map management table 131 at step S12 described above, i.e., the job ID of the job which has generated the Map result to be reused. The job tracker 142 then searches the Reduce management table 132 for a record including the job ID concerned.

(Step S133) The job tracker 142 determines whether or not there exists an unselected Reduce task in the Reduce tasks defined at step S11 described above. The process flow proceeds to step S134 when there exists an unselected Reduce task, and the process is terminated when all the Reduce tasks have been selected.

(Step S134) The job tracker 142 selects one of the Reduce tasks defined at step S11 described above.

(Step S135) The job tracker 142 determines whether or not there exists, in the record searched at step S132, a record whose Reduce number is common to the Reduce task selected at step S134. In other words, the job tracker 142 determines, for the selected Reduce task, whether or not there exists a reusable Reduce input. The process flow proceeds to step S136 when there exists a reusable Reduce input, and proceeds to step S133 when there is none.

(Step S136) The job tracker 142 supplements the information of the columns for allocated node and intermediate data path included in the task list 122. The allocated node and the intermediate data path are described in the column for intermediate data set of the Reduce management table 132.

(Step S137) The job tracker 142 updates the use history of the record in the Reduce management table 132 which has been referred to when updating the task list 122 at step S136. For example, the job tracker 142 rewrites the use history to the current date and time. The process flow then proceeds to step S133.

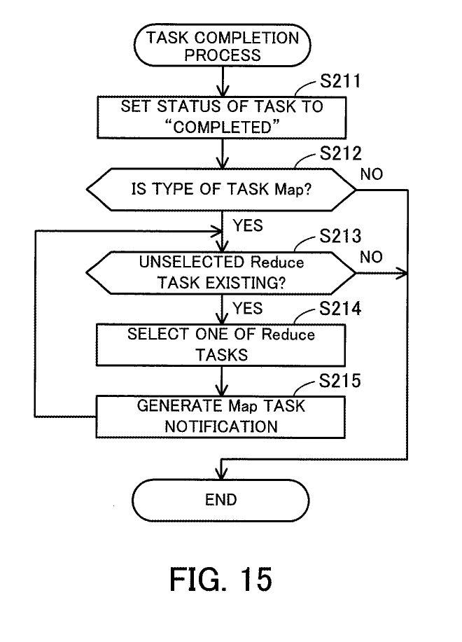

FIG. 15 is a flowchart illustrating an exemplary procedure of a task completion process. The procedure illustrated in the flowchart of FIG. 15 is performed at steps S21 and S126 described above.

(Step S211) The job tracker 142 sets, in the task list 122, the status of a task whose completion has been reported or a task considered to have been completed, to “completed”.

(Step S212) The job tracker 142 determines whether or not the type of the task whose status has been set to “completed” at step S211 is “Map”. The process flow proceeds to step S213 when the type is “Map”, and the process is terminated when the type is “Reduce”.

(Step S213) Referring to the task list 122, the job tracker 142 searches for a Reduce task belonging to the same job as the Map task whose status has been set to “completed” at step S211, and determines whether or not there exists an unselected Reduce task. The process flow proceeds to step S214 when there exists an unselected Reduce task, and the process is terminated when all the Reduce tasks have been selected.

(Step S214) The job tracker 142 selects one of the Reduce tasks belonging to the same job as the Map task whose status has been set to “completed” at step S211.

(Step S215) The job tracker 142 generates, and stores in the notification buffer 123, a Map task notification to be transmitted to the Reduce task selected at step S214. The Map task notification generated here includes, as illustrated in FIG. 11, an identifier of a Map task set to “completed”, an allocated node and an intermediate data path registered in the task list 122. The status of the Reduce task selected at step S214 may be “unallocated” at the time when the Map task notification is generated. In such a case, the Map task notification stored in the notification buffer 123 is transmitted after the Reduce task has been allocated to one of the slave nodes. The process flow then proceeds to step S213.

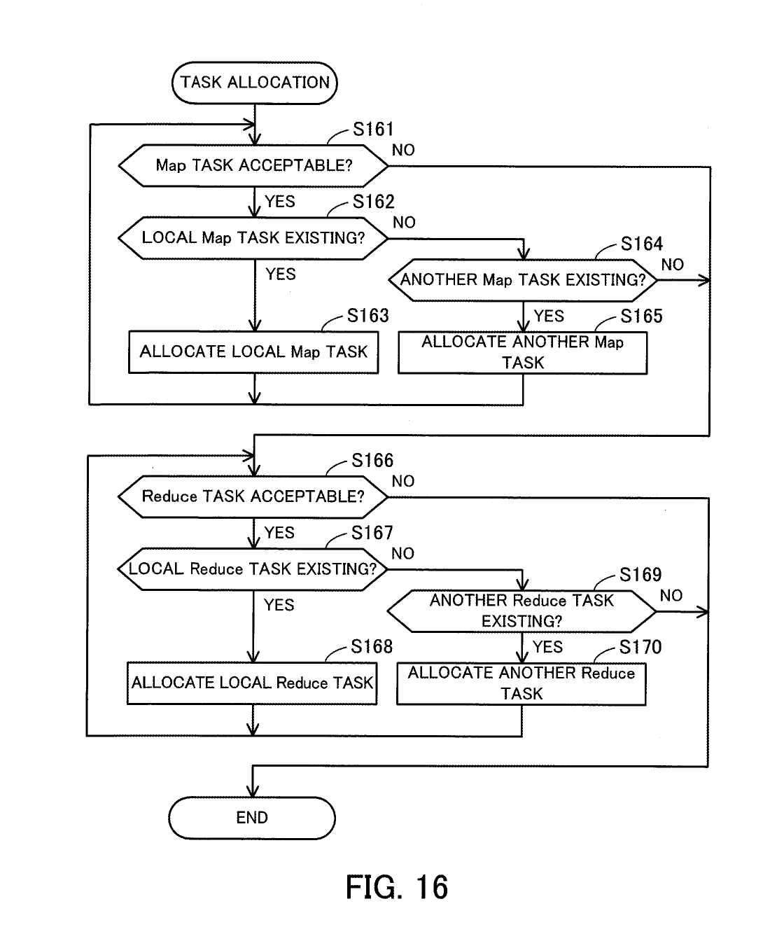

FIG. 16 is a flowchart illustrating an exemplary procedure of task allocation. The process illustrated in the flowchart of FIG. 16 is performed at step S16 described above.

(Step S161) The job tracker 142 determines whether or not the slave node which has transmitted the task request notification is capable of accepting a new Map task, i.e., whether or not the number of Map tasks currently being performed in the slave node is smaller than the upper limit. The process flow proceeds to step S162 when a new Map task is acceptable, and proceeds to step S166 when it is unacceptable. The upper limit of the number of Map tasks for each slave node may be preliminarily registered in the master node 100, or may be notified to the master node 100 by each slave node.

(Step S162) The job tracker 142 determines whether or not there exists, among unallocated Map tasks, a “local Map task” for the slave node which has transmitted the task request notification. A local Map task is a Map task for which the segment of input data is stored in the slave node, and thus transfer of the input data may be omitted. Whether or not each Map task is a local Map task may be determined by whether or not the identifier of the slave node which has transmitted the task request notification is registered in the column for data node of the task list 122. The process flow proceeds to step S163 when there exists a local Map task, and proceeds to step S164 when there is none.

(Step S163) The job tracker 142 allocates one of the local Map tasks found at step S162 to the slave node which has transmitted the task request notification. The job tracker 142 registers the identifier of the slave node as the allocated node of the local Map task in the task list 122 and, additionally, sets the status of the local Map task to “running”. The process flow then proceeds to step S161.

(Step S164) Referring to the task list 122, the job tracker 142 determines whether or not there exists an unallocated Map task other than the local Map task. The process flow proceeds to step S165 when there exists such an unallocated Map task, and proceeds to step S166 when there is none.

(Step S165) The job tracker 142 allocates one of the Map tasks found at step S164 to the slave node which has transmitted the task request notification. The job tracker 142 registers, similarly to step S163, the identifier of the slave node as the allocated node of the Map task in the task list 122 and, additionally, sets the status of the Map task to “running”. The process flow then proceeds to step S161.

(Step S166) The job tracker 142 determines whether or not the slave node which has transmitted a task request notification is capable of accepting a new Reduce task, i.e., whether or not the number of Reduce tasks currently being performed in the slave node is smaller than the upper limit. The process flow proceeds to step S167 when a new Reduce task is acceptable, and the process is terminated when it is unacceptable. The upper limit of the number of Reduce tasks for each slave node may be preliminarily registered in the master node 100, or may be notified to the master node 100 by each slave node.

(Step S167) The job tracker 142 determines whether or not there exists, among unallocated Reduce tasks, a “local Reduce task” for the slave node which has transmitted the task request notification. A local Reduce task is a Reduce task for which the intermediate data set representing the Reduce input collected from the Map task is stored in the slave node, and thus the number of transfers of intermediate data sets may be reduced. Whether or not each Reduce task is a local Reduce task may be determined by whether or not the identifier of the slave node which has transmitted the task request notification is registered in the column for data node of the task list 122. The process flow proceeds to step S168 when there exists a local Reduce task, and proceeds to step S169 when there is none.

(Step S168) The job tracker 142 allocates one of the local Reduce tasks found at step S167 to the slave node which has transmitted the task request notification. The job tracker 142 registers, in the task list 122, the identifier of the slave node as an allocated node of the local Reduce task and, additionally, sets the status of the local Reduce task to “running”. The process flow then proceeds to step S166.

(Step S169) Referring to the task list 122, the job tracker 142 determines whether or not there exists an unallocated Reduce task other than the local Reduce task. The process flow proceeds to step S170 when there exists such an unallocated Reduce task, and the process is terminated when there is none.

(Step S170) The job tracker 142 allocates one of the Reduce tasks found at step S169 to the slave node which has transmitted the task request notification. The job tracker 142 registers, similarly to step S168, the identifier of the slave node as the allocated node of the Reduce task 122 in the task list, and sets the status of the Reduce task to “running”. The process flow then proceeds to step S166.

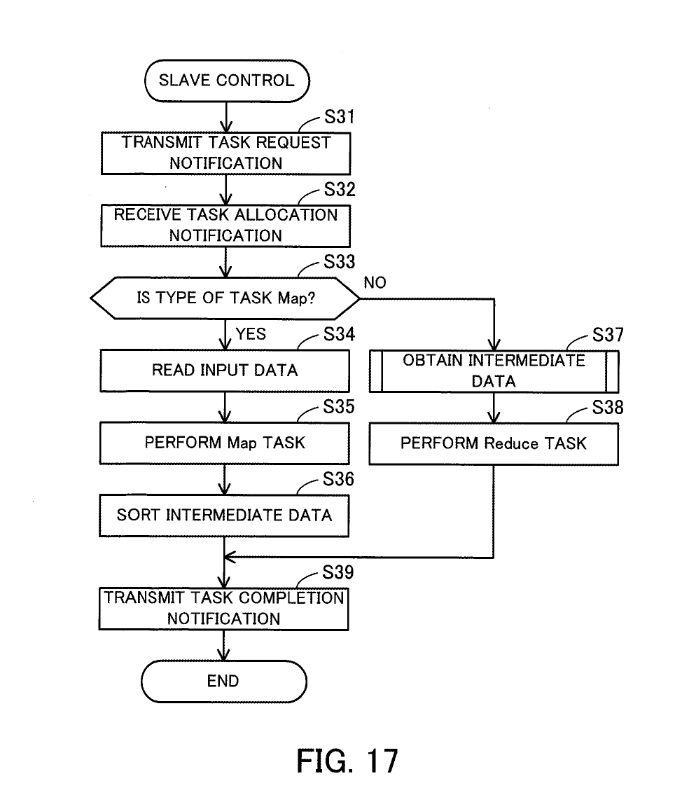

FIG. 17 is a flowchart illustrating an exemplary procedure of slave control.

(Step S31) The task tracker 221 transmits a task request notification to the master node 100. The task request notification includes the identifier of the slave node 200.

(Step S32) The task tracker 221 receives a task allocation notification from the master node 100 as a response to the task request notification which has been transmitted at step S31. The task allocation notification includes one of the records in the job list 121 and one of the records in the task list 122 for each allocated task. The processes of the following steps S33 to S39 are performed for each allocated task.

(Step S33) The task tracker 221 determines whether or not the type of the task allocated to the slave node 200 is Map. The process flow proceeds to step S34 when the type is Map, and proceeds to step S37 when the type is Reduce.

(Step S34) The task tracker 221 reads the segment of input data specified by the task allocation notification. The input data may be stored in the slave node 200, or may be stored in another slave node or the DB server 42.

(Step S35) The task tracker 221 invokes the Map execution unit 222 (e.g., a new process for performing a Map process is activated in the slave node 200). According to the Map definition 111 specified by the task allocation notification, the Map execution unit 222 performs a Map process on the segment of input data which has been read at step S34.

(Step S36) The Map execution unit 222 stores the intermediate data set representing the Map result in the Map result storage unit 211. The Map execution unit 222 sorts, based on a key, records included in the intermediate data set in the key-value format, and creates a file for each set of records handled by the same Reduce task. A Reduce number is assigned as the name of each file. The created file is stored in a directory identified by the job ID and the task ID of the Map task. The process flow then proceeds to step S39.

(Step S37) The task tracker 221 obtains an intermediate data set to be handled by the Reduce task allocated to the slave node 200. The task tracker 221 stores the obtained intermediate data set in the Reduce input storage unit 212, and merges the records included in the intermediate data set according to a key. Details of obtaining the intermediate data set will be described below.

(Step S38) The task tracker 221 invokes the Reduce execution unit 223 (e.g., a new process for performing a Reduce process is activated by the slave node 200). The Reduce execution unit 223 performs a Reduce process on the intermediate data set having the records merged at step S37, according to the Reduce definition 112 specified by the task allocation notification. The Reduce execution unit 223 then stores output data set generated as the Reduce result in the Reduce result storage unit 213.

(Step S39) The task tracker 221 transmits a task completion notification to the master node 100. The task completion notification includes the identifier of the slave node 200, the identifier of the completed task, and the path of the directory storing the intermediate data set. The directory is the directory of the Map result storage unit 211 storing the generated Map result when the completed task is a Map task, and the directory of the Reduce input storage unit 212 storing the collected Reduce input when the completed task is a Reduce task.

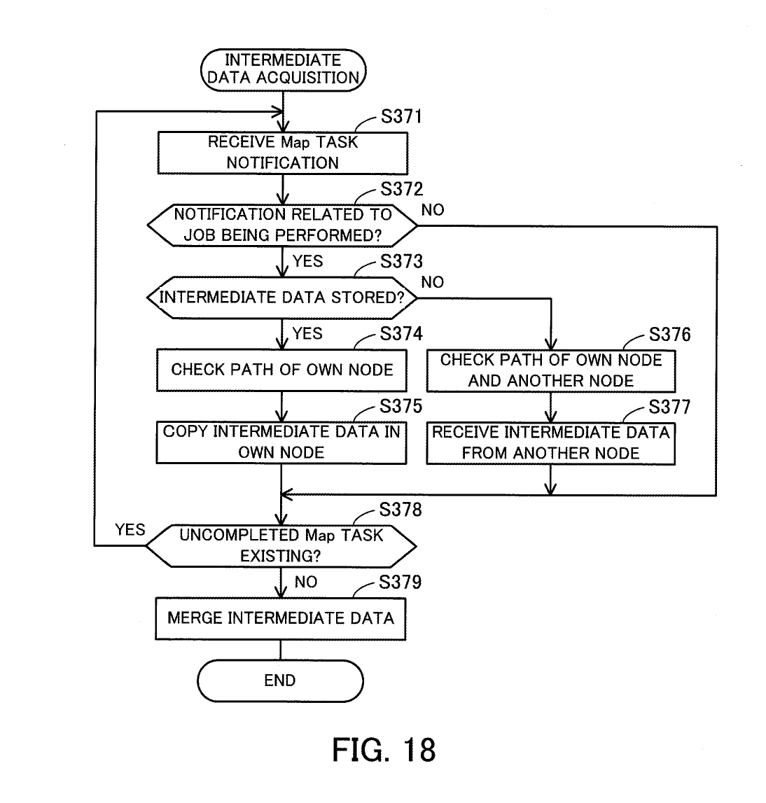

FIG. 18 is a flowchart illustrating an exemplary procedure of the intermediate data set acquisition. The process illustrated in the flowchart of FIG. 18 is performed at step S37 described above.

(Step S371) The task tracker 221 receives a Map task notification from the master node 100. When there exists a Map task which has already been completed at the time when the Reduce task is allocated to the slave node 200, the Map task notification relating to the Map task is received together with the task allocation notification, for example. When there exists a Map task which has not yet been completed at the time when the Reduce task is allocated to the slave node 200, the Map task notification relating to the Map task is received after the Map task has been completed.

(Step S372) The task tracker 221 determines whether or not the Map task notification received at step S371 relates to a job being performed in the slave node 200. In other words, the task tracker 221 determines whether or not the job ID included in the Map task notification coincides with the job ID included in a previously received task allocation notification. The process flow proceeds to step S373 when the condition is satisfied, or otherwise proceeds to step S378.

(Step S373) The task tracker 221 determines whether or not the intermediate data set to be processed by the Reduce task allocated to the slave node 200, among the intermediate data sets specified by the Map task notification, is already stored in the Reduce input storage unit 212. The presence or absence of storage is determined by whether or not the name (task ID of the Map task) of one of the files stored in the Reduce input storage unit 212 coincides with the task ID of the Map task described as a part of the intermediate data path specified by the Map task notification. The process flow proceeds to step S374 when the intermediate data set representing the Reduce input is stored, and proceeds to step S376 when it is not stored.

(Step S374) The task tracker 221 checks the path of the directory (copy source) storing the file found at step S373. In addition, the task tracker 221 calculates, from the job ID and the task ID of the Reduce task, the path of the directory (copy destination) for the allocated Reduce task.

(Step S375) The task tracker 221 copies, in the slave node 200, the file of the intermediate data set from the copy source checked at step S374 to the copy destination. The task ID of the completed Map task specified by the Map task notification is used as the name of the copied file. The process flow then proceeds to step S378.

(Step S376) The task tracker 221 checks the path of the directory (copy source) of another slave node specified by the Map task notification. In addition, the task tracker 221 calculates, from the job ID and the task ID of the Reduce task, the path of the directory (copy destination) for the allocated Reduce task.

(Step S377) The task tracker 221 accesses the another slave node and receives, from the copy source checked at step S376, the file bearing the number of the allocated Reduce task. The task tracker 221 then stores the received file in the copy destination checked at step S376. The task ID of the completed Map task specified by the Map task notification is used as the name of the copied file.

(Step S378) The task tracker 221 determines whether or not there exists an uncompleted Map task. The presence or absence of an uncompleted Map task is determined by whether or not the number of received Map task notifications coincides with the number of Map tasks specified by the task allocation notification. The process flow proceeds to step S371 when there exists an uncompleted Map task, and proceeds to step S379 when there is none.

(Step S379) The task tracker 221 merges the intermediate data sets stored in the directory for the allocated Reduce task, according to a key.

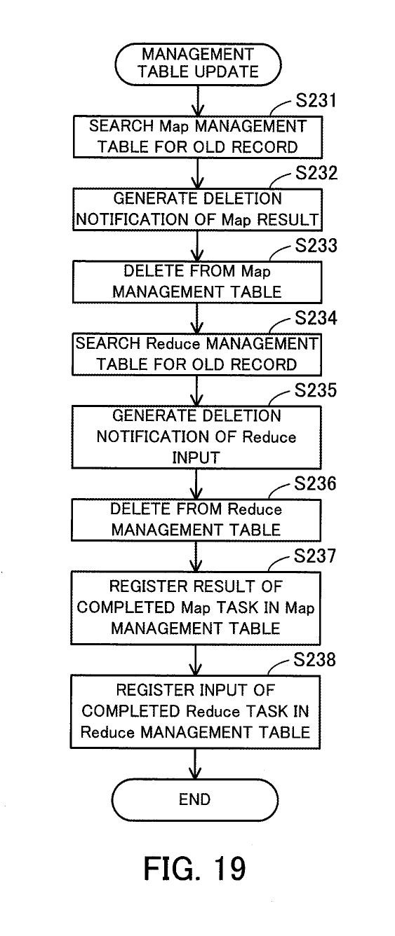

FIG. 19 is a flowchart illustrating an exemplary procedure of management table update. The process illustrated in the flowchart of FIG. 19 is performed at step S23 described above.

(Step S231) The job tracker 142 searches the Map management table 131 for an old record. For example, the job tracker 142 searches for, as an old record, a record whose elapsed time is equal to or greater than a certain period of time from the date and time described as the use history.

(Step S232) The job tracker 142 generates, and stores in the notification buffer 123, a deletion notification addressed to the slave node specified in the record searched at step S231. The deletion notification includes information of the intermediate data path specified in the record searched, as the information indicating the intermediate data set to be deleted.

(Step S233) The job tracker 142 deletes the record searched at step S231 from the Map management table 131.

(Step S234) The job tracker 142 searches the Reduce management table 132 for an old record. For example, the job tracker 142 searches for, as an old record, a record whose elapsed time is equal to or greater than a certain period of time from the date and time described as the use history.

(Step S235) The job tracker 142 generates, and stores in the notification buffer 123, a deletion notification addressed to the slave node specified in the record searched at step S234. The deletion notification includes information of the intermediate data path specified in the record searched, as the information indicating the intermediate data set to be deleted.

(Step S236) The job tracker 142 deletes the record searched at step S234 from the Reduce management table 132.

(Step S237) By performing the current job, referring to the task list 122, the job tracker 142 adds, to the Map management table 131, the information relating to the intermediate data set stored in the slave node to which the Map task has been allocated.

(Step S238) By performing the current job, referring to the task list 122, the job tracker 142 adds, to the Reduce management table 132, information relating to the intermediate data set stored in the slave node to which the Reduce task has been allocated.

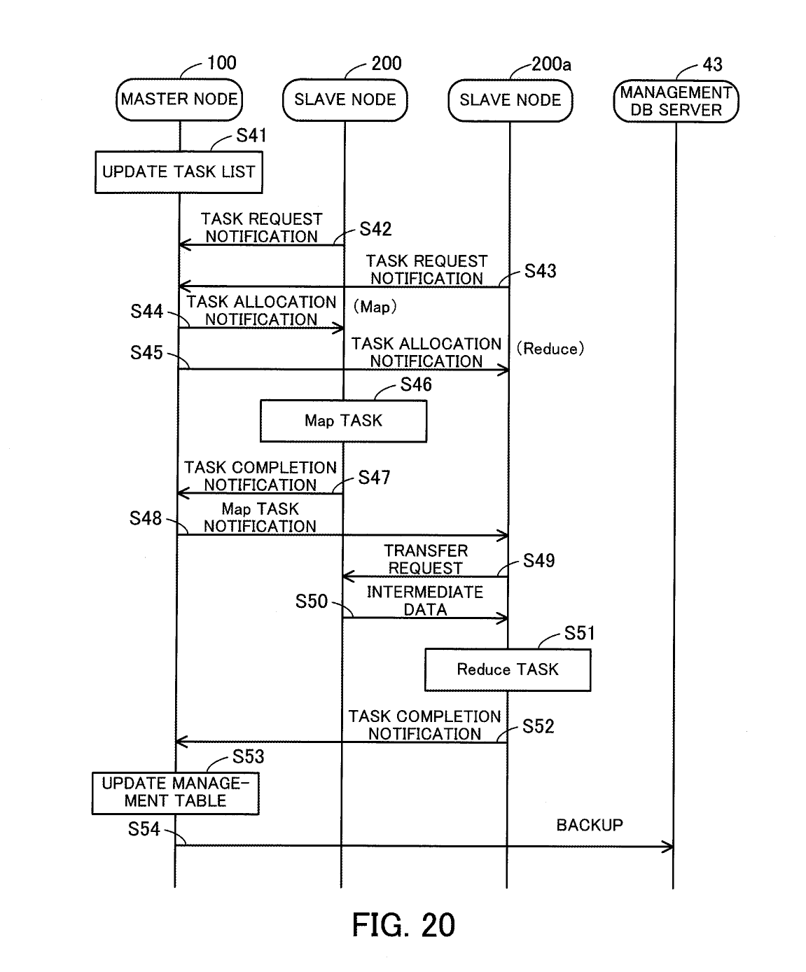

FIG. 20 illustrates an exemplary sequence of a MapReduce process. The exemplary sequence of FIG. 20 considers a case where the master node 100 allocates a Map task to the slave node 200, and allocates a Reduce task to the slave node 200a.

The master node 100 defines, and registers in the task list 122, a Map task and a Reduce task (Step S41). The slave node 200 transmits a task request notification to the master node 100 (Step S42). Similarly, the slave node 200a transmits a task request notification to the master node 100 (Step S43). The master node 100 allocates a Map task to the slave node 200, and transmits a task allocation notification indicating the Map task to the slave node 200 (Step S44). In addition, the master node 100 allocates a Reduce task to the slave node 200a, and transmits a task allocation notification indicating the Reduce task to the slave node 200a (Step S45).

The slave node 200 performs a Map task according to the task allocation notification (Step S46). Subsequently, upon completion of the Map task, the slave node 200 transmits a task completion notification to the master node 100 (Step S47). The master node 100 transmits, to the slave node 200a to which the Reduce task has been allocated, a Map task notification indicating that the Map task has been completed in the slave node 200 (Step S48). Having received the Map task notification, the slave node 200a transmits a transfer request to the slave node 200 (Step S49). The slave node 200 transfers, to the slave node 200a, the intermediate data set to be processed by the Reduce task of the slave node 200a, among the intermediate data sets generated at step S46 (Step S50).

The slave node 200a performs a Reduce task on the intermediate data set received at step S50, according to the task allocation notification (Step S51). Subsequently, upon completion of the Reduce task, the slave node 200a transmits a task completion notification to the master node 100 (Step S52). Upon completion of the job, the master node 100 updates the Map management table 131 and the Reduce management table 132 (Step S53). The master node 100 backs up the updated Map management table 131 and Reduce management table 132 to the management DB server 43 (Step S54).

According to the information processing system of the second embodiment, when the intermediate data set for a particular segment of input data is stored in any of the nodes which have previously performed a Map task, a Map process for the segment may be omitted. Therefore, the amount of computing in the data processing may be reduced. Furthermore, when at least a part of the intermediate data set is stored in any of the slave nodes which have previously performed a Reduce task, the number of transfers of intermediate data sets may be reduced by allocating the Reduce task to the slave node. Therefore, waiting time of communication may be reduced, and also the load on the network 30 may be reduced.

As has been described above, the information processing of the first embodiment may be implemented by causing the information processing apparatus 10 and the nodes 20 and 20a to execute a program, while the information processing of the second embodiment may be implemented by causing the master node 100 and the slave nodes 200, 200a, 200b and 200c to execute a program. Such a program may be stored in a computer-readable storage medium (e.g., storage medium 53). A magnetic disk, an optical disk, a magneto-optical disk, a semiconductor memory or the like may be used as a storage medium, for example. An FD or an HDD may be used as a magnetic disk. A CD, a CD-R (Recordable)/RW (Rewritable), a DVD, or a DVD-R/RW may be used as an optical disk.

When distributing a program, a portable storage medium having stored the program thereon is provided, for example. In addition, the program may be stored in a storage device of another computer and the program may be distributed via the network 30. The computer, for example, stores, in a storage device (e.g., HDD 103), a program stored in the portable storage medium or a program received from another computer, reads the program from the storage device and executes it. However, the program read from the portable storage medium may also be directly executed, or the program received from another computer via the network 30 may be directly executed. In addition, at least a part of the information processing may be implemented by an electronic circuit such as a DSP, an ASIC, a PLD (Programmable Logic Device), or the like.

In one aspect, it is possible to reduce the number of transfers of data between nodes.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A data processing method performed by a system which uses a plurality of nodes to perform a first process on an input data set and a second process on a result of the first process, the method comprising:
selecting, by a processor, a first node and a second node from the plurality of nodes, in response to a specification of an input data set including a first segment and a second segment, the second segment being on which the first process was previously performed, the second node storing at least a part of a result of the first process previously performed on the second segment;
instructing, by the processor, the first node to perform the first process on the first segment and to transfer at least a part of a result of the first process on the first segment to the second node; and
instructing, by the processor, the second node to perform the second process on the at least part of the result of the first process on the first segment transferred from the first node, and the at least part of the result, which has been stored in the second node, of the first process previously performed on the second segment.

2. The data processing method according to claim 1, wherein the selected second node is a node which previously obtained the at least part of the result of the first process on the second segment and performed the second process.

3. The data processing method according to claim 1, wherein
the second node has stored a record including a predetermined key, among records included in the result of the first process previously performed on the second segment, and
a record including the predetermined key, among records included in the result of the first process on the first segment, is transferred from the first node to the second node.

4. The data processing method according to claim 1, wherein the at least part of the result of the first process on the first segment transferred from the first node is stored in the second node without being erased, until at least a predetermined time elapses after the second process is performed.

5. The data processing method according to claim 1, wherein:
information indicating a correspondence relation between a segment included in a previously specified input data set and a node storing at least a part of a result of the first process previously performed is stored and managed in a storage device included in the system; and
the first and second nodes are selected with reference to the storage device.

6. An information processing apparatus used for controlling a system which uses a plurality of nodes to perform a first process on an input data set and a second process on a result of the first process, the apparatus comprising:
a memory configured to store information indicating a correspondence relation between a segment included in an input data set and a node storing at least a part of a result of the first process previously performed; and
a processor configured to perform a process including:
selecting a first node and a second node from the plurality of nodes, in response to a specification of an input data set including a first segment and a second segment, the second segment being on which the first process was previously performed, the second node storing at least a part of a result of the first process previously performed on the second segment;
instructing the first node to perform the first process on the first segment and to transfer at least a part of a result of the first process on the first segment to the second node; and
instructing the second node to perform the second process on the at least part of the result of the first process on the first segment transferred from the first node, and the at least part of the result, which is stored in the second node, of the first process previously performed on the second segment.

7. A non-transitory computer-readable storage medium storing a computer program that causes a computer to perform a process for controlling a system which uses a plurality of nodes to perform a first process on an input data set and a second process on a result of the first process, the process comprising:
selecting a first node and a second node from the plurality of nodes in response to a specification of an input data set including a first segment and a second segment, the second segment being on which the first process was previously performed, the second node storing at least a part of a result of the first process previously performed on the second segment;
instructing the first node to perform the first process on the first segment and to transfer at least a part of a result of the first process on the first segment to the second node; and
instructing the second node to perform the second process on the at least part of the result of the first process on the first segment transferred from the first node, and the at least part of the result, which is stored in the second node, of the first process previously performed on the second segment.
